(19) United States
(12) Patent Application Publication
(10) Pub. No.: US 2008/0030646 A1
(43) Pub. Date: Feb. 7, 2008

(54) LIQUID CRYSTAL DISPLAY DEVICE

(76) Inventor: Seong-hyun Go, Yongin-si (KR)

Correspondence Address: F. CHAU & ASSOCIATES, LLC, 130 WOODBURY ROAD, WOODBURY, NY, 11797, US

(21) Appl. No.: 11/832,069

(22) Filed: Aug. 1, 2007

(30) Foreign Application Priority Data
Aug. 3, 2006 (KR) 2006-0073441

(51) Int. Cl. G02F 1/13357

(52) U.S. Cl. 349/62

(57) ABSTRACT

A liquid crystal display device, comprises a liquid crystal display panel; a light source part disposed along at least one side of the liquid crystal display panel; a light source cover, the light source cover reflecting light emitted from the light source part to the liquid crystal display panel; a panel supporting part disposed under an edge part of the liquid crystal display panel to support the liquid crystal display panel; and an optical film disposed under the liquid crystal display panel, and comprising a first area facing the liquid crystal display panel, and a second area extending below the panel supporting part, the second area comprising a plurality of protrusion parts and a plurality of cut parts alternately formed at an end of the second area, and at least part of the protrusion parts are provided on the light source cover.

### CROSS-REFERENCE TO RELATED APPLICATION

This application claims the benefit of Korean Patent Application No. 2006-0073441 filed on Aug. 03, 2006, the disclosure of which is incorporated herein by reference in its entirety.

### BACKGROUND OF THE INVENTION

1. Technical Field

The present disclosure relates to an LCD device, and more particularly, to an LCD device including a panel supporting part supporting an LCD panel, and an optical film.

2. Discussion of the Related Art

Flat panel display apparatuses such as an LCD (Liquid Crystal Display) device, a PDP (Plasma Display Panel) device, and an OLED (Organic Light Emitting Diode) display device have been developed to replace a conventional CRT (Cathode-Ray Tube) display device.

The LCD device includes an LCD panel and a backlight unit. The LCD panel includes a thin film transistor substrate, a color filter substrate, and a liquid crystal layer provided therebetween. The LCD panel does not emit light by itself, and thus, a backlight unit provides light to the LCD panel. The transmittance of light provided from the backlight unit is adjusted according to an alignment of liquid crystal.

The backlight unit includes a light source to generate light, and an optical film provided between the light source and the LCD panel. The optical film changes properties of the light provided from the light source, to provide a uniform light having a high level of brightness to the LCD panel.

The optical film is combined with a panel supporting part that supports the LCD panel. However, when a reliability test including vibrating the LCD panel is performed, the optical film may be separated from the panel supporting part.

Further, as the width of the panel supporting part is reduced to decrease the size of the LCD device, the optical film may be more likely to separate from the panel supporting part as an area of the panel supporting part decreases.

### SUMMARY OF THE INVENTION

Embodiments of the present invention provide an LCD device including an optical film capable of being stably supported.

A liquid crystal display device, in accordance with an embodiment of the present invention, comprises a liquid crystal display panel; a light source part disposed along at least one side of the liquid crystal display panel; a light source cover, the light source cover reflecting light emitted from the light source part to the liquid crystal display panel; a panel supporting part disposed under an edge part of the liquid crystal display panel to support the liquid crystal display panel; and an optical film disposed under the liquid crystal display panel, and comprising a first area facing the liquid crystal display panel, and a second area extending below the panel supporting part, the second area comprising a plurality of protrusion parts and a plurality of cut parts alternately formed at an end of the second area, and at least part of the protrusion parts are provided on the light source cover.

The cuts parts may extend into the first area.

The protrusion parts may be partially superposed on the light source cover.

Each of the protrusion parts facing the light source cover may comprise at least one of a rectangular, a trapezoid, or a semicircular shape.

The cut parts may become wider as a distance between the cut parts and the first area increases.

The protrusion parts may extend to the first area, the liquid crystal display panel may comprise an outer black matrix formed along a perimeter of the liquid crystal display panel, and the protrusion parts may be positioned below the outer black matrix.

The light source part may comprises a lamp; and the density of the protrusion parts corresponding to ends of the light source part may be lower than the density of the protrusion parts corresponding to a center part of the light source part.

The light source part may comprise a light emitting diode, and the density of the protrusion parts may be uniform.

The optical film may comprise a plurality of sub-optical films, and the protrusion parts may be formed on the uppermost sub-optical film.

The uppermost sub-optical film may be larger than the other sub-optical films.

The optical film may have a square shape, and the protrusion parts may be formed on four sides of the optical film.

A liquid crystal display device, according to an embodiment of the present invention, comprises a liquid crystal display panel; a light source part disposed along at least one side of the liquid crystal display panel; a light source cover, the light source cover reflecting light emitted from the light source part to the liquid crystal display panel; a panel supporting part, the panel supporting part supporting the liquid crystal display panel; and an optical film disposed under the liquid crystal display panel, the optical film extending between the panel supporting part and the light source cover, and comprising a plurality of protrusion parts and a plurality of cut parts alternately formed at an end of the optical film, wherein the protrusion parts are partially superposed on the light source cover.

The cut part not facing the light source cover may become wider as a distance between the cut part and a center portion of the light guide plate increases.

A liquid crystal display device, according to an embodiment of the present invention, comprises a liquid crystal display panel; a light source part disposed along at least one side of the liquid crystal display panel; a light source cover, the light source cover reflecting light emitted from the light source part to the liquid crystal display panel; a panel supporting part disposed under an edge part of the liquid crystal display panel to support the liquid crystal display panel; and an optical film disposed under the liquid crystal display panel, and comprising a first area facing the liquid crystal display panel, and a second area extending below the panel supporting part, the second area comprising a plurality of protrusion parts and a plurality of cut parts alternately formed at an end of the second area.

At least part of the protrusion parts may be provided on the light source cover.

The cut parts may extend into the first area.

The protrusion parts may extend to the first area, the liquid crystal display panel may comprise an outer black matrix formed along a perimeter of the liquid crystal display panel, and the protrusion parts may be positioned below the outer black matrix.

The light source part may comprise a lamp; and the density of the protrusion parts corresponding to ends of the light source part may be lower than the density of the protrusion parts corresponding to a center part of the light source part.

The optical film may comprise a plurality of sub-optical films, and the protrusion parts may be formed on the uppermost sub-optical film.

The optical film may have a square shape, and the protrusion parts may be formed on four sides of the optical film.

### BRIEF DESCRIPTION OF THE DRAWINGS

Exemplary embodiments of the present invention can be understood in more detail from the following description, taken in conjunction with the accompanying drawings of which:

FIG. 1 is an exploded perspective view illustrating an LCD device according to an embodiment of the present invention;

FIG. 2 is a sectional view illustrating an LCD device according to an embodiment of the present invention;

FIG. 3 is an enlarged view of a part ‘A’ of FIG. 2;

FIG. 4 is a plan view illustrating an optical film of an LCD device according to an embodiment of the present invention;

FIG. 5 is illustrates a relationship of an optical film, a panel supporting part, and a light source cover of an LCD device according to an embodiment of the present invention;

FIGS. 6 through 9 are plan views illustrating an optical film of an LCD device according to embodiments of the present invention;

FIGS. 10 through 12 are views illustrating a relationship of an optical film, a panel supporting part, and a light source cover of an LCD device according to embodiments of the present invention;

FIG. 13 illustrates a relationship of an optical film, a panel supporting part, and an outer black matrix of an LCD device according to an embodiment of the present invention;

FIG. 14 illustrates a configuration of an optical film of an LCD device according to an embodiment of the present invention; and

FIG. 15 is a sectional view of an LCD device according to an embodiment of the present invention.

### DETAILED DESCRIPTION OF EXEMPLARY EMBODIMENTS

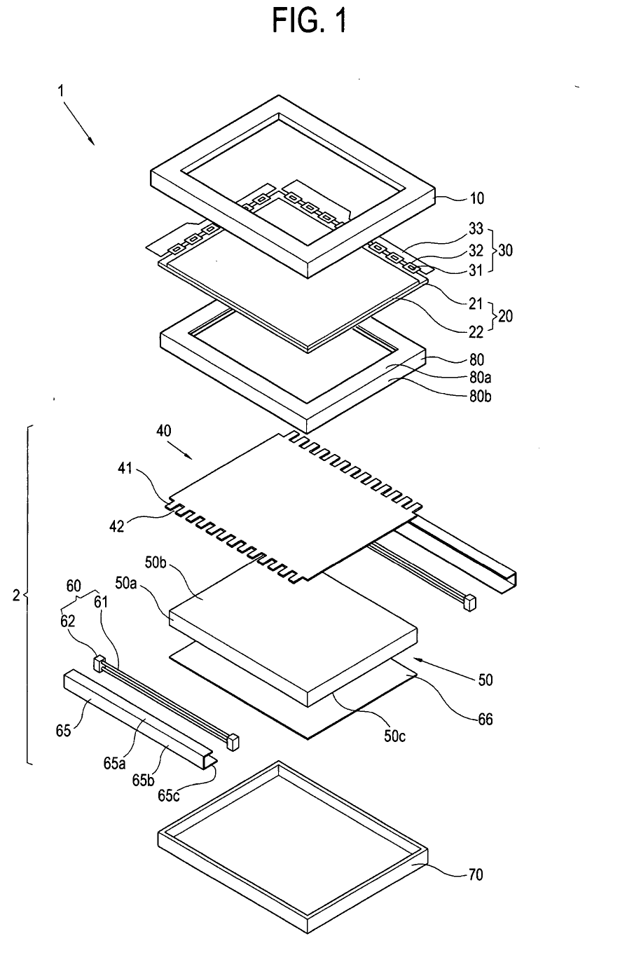

Exemplary embodiments of the present invention will now be described more fully hereinafter below in more detail with reference to the accompanying drawings. This invention may, however, be embodied in different forms and should not be construed as limited to the embodiments set forth herein. An LCD device according to an embodiment of the prevent invention will be described with reference to FIGS. 1 through 5.

As illustrated in FIG. 1, the LCD device 1 includes an LCD panel 20 and a backlight unit 2 provided behind the LCD panel 20. The backlight unit 2 includes an optical film 40 provided behind the LCD panel 20, a light guide plate 50 provided behind the LCD panel 20, a pair of light source parts 60 provided along opposite sides of the light guide panel 50, and a reflecting plate 66 below the light guide plate 50. The LCD panel 20 and the backlight unit 2 are provided between an upper receiving member 10 and a lower receiving member 70. A panel supporting part 80 supports the LCD panel 20. The panel supporting part 80 may be formed of a plastic material.

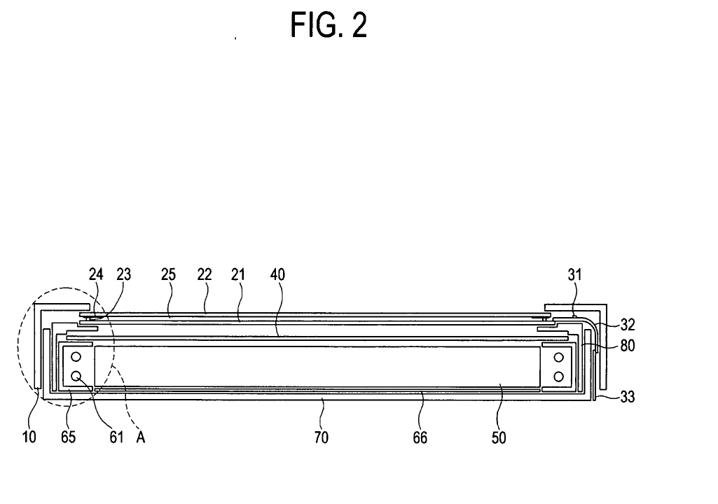

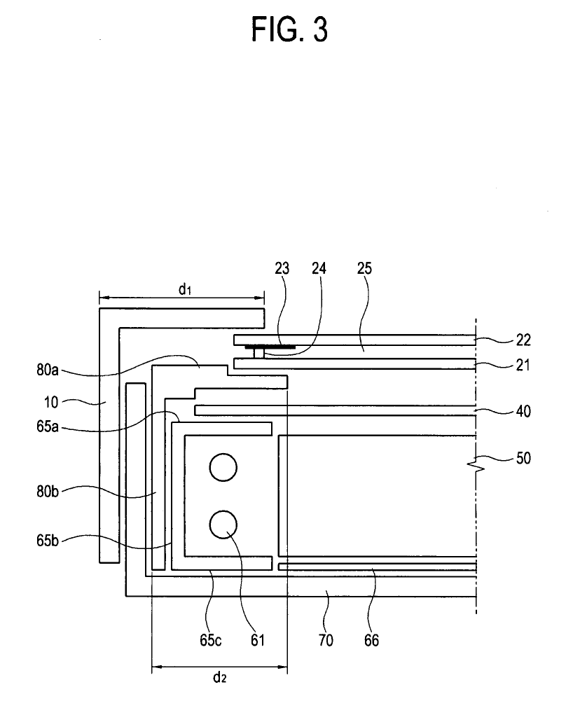

The LCD panel 20 includes a thin film transistor substrate 21 formed with a thin film transistor, and a color filter substrate 22 facing the thin film transistor 21. As illustrated in FIGS. 2 and 3, an outer black matrix 23 is provided on the color filter substrate 22. The outer black matrix 23 includes, for example, chrome or a black colored material to block light transmission. The outer black matrix 23 is provided along a perimeter of the LCD panel 20.

As illustrated in FIGS. 2 and 3, a sealant 24 is provided below the outer black matrix 23. The sealant 24 combines the thin film transistor substrate 21 and the color filter substrate 22. The liquid crystal layer 25 is provided in a space formed between both substrates 21 and 22 and the sealant 24.

A driving part 30 is provided on a part of the thin film transistor substrate 21 to apply a driving signal thereto. The driving part 30 includes a driving chip 31, a FPCB (Flexible Printed Circuit Board) 32 formed with the driving chip 31, and a PCB (Printed Circuit Board) 33 connected with the FPCBs 32. The driving part 30 illustrated in FIGS. 1 and 2 is a COP (Chip on Film) type. Alternatively, the driving part 30 may be other known types such as a TCP (Tape Carrier Package) type and a COG (Chip on Glass) type. In addition, the driving part 30 may be mounted on the thin film transistor substrate 21.

The optical film 40, which is provided behind the LCD panel 20, has an approximately rectangular shape. The optical film 40 may be provided as one of various films such as a diffusion film, a prism film, a reflection polarization film, and a passivation film. Alternatively, the optical film 40 may include a plurality of the films. A protrusion part 41 and a cut part 42 are alternately formed along a longer side of the optical film 40.

The light guide plate 50 includes an acrylic resin such as a polymethylstyrene resin or a PMMA (polymethylmethacrylate) resin. The polymethylstyrene resin is a copolymer of the PMMA resin and a styrene resin. The light guide plate 50 uniformly provides light emitted from the light source part 60 to the optical film 40.

The light guide plate 50 includes a light incident side area 50a facing the light source part 60, a light exit side area 50b facing the optical film 40, and a reflecting side area 50c provided parallel to the light exit side area 50b. A pattern shape, including, for example, one or more grooves may be formed on the reflecting side 50c to improve the brightness.

Between the opposing pairs of light source parts 60 is provided the light guide plate 50. Each light source 60 includes a lamp 61 and a pair of lamp holders 62 provided on opposite ends of the lamp 61. The light source part 60 may include a CCFL (Cold Cathode Fluorescent Lamp) or an EEFL (External Electrode Fluorescent Lamp).

A light source cover 65 partially surrounds the respective light sources 60 and reflects light emitted from the light sources 60 toward the light guide plate 50. The light source cover 65 may include two layers. One layer, e.g., an internal layer facing the light source 60, may include PET (polyethylentere-phthalate). The other layer, e.g., an external layer may include aluminum having high thermal conductivity. The light source cover 65 includes a first side 65a and a second side 65c provided parallel to the LCD panel, and a third side 65b to combine the first side 65a and the second side 65c.

The reflecting plate 66 is provided below the light guide plate 50 to reflect light to the light guide plate 50. The reflecting plate 66 may include a plastic material such as PET and PC (polycarbonate).

The LCD panel 20 and the backlight unit 2 are provided between the upper receiving member 10 and the lower receiving member 70.

The LCD panel 20 is supported by the supporting part 80. The panel supporting part 80 is spaced from the light guide plate 50 at a predetermined distance. The panel supporting part 80 includes a first part 80a provided parallel to the LCD panel 20 to support the LCD panel 20, and a second part 80b to be bent (e.g., at about 90 degrees) from the first part 80a, and to surround the light source cover 65.

As illustrated in FIG. 3, the optical film 40 is provided between the LCD panel 20 and the light guide plate 50. A part of the optical film 40 may extend beyond the light guide plate 50 to below the panel supporting part 80. Particularly, the extended part of the optical film 40 faces the light source cover 65. The optical film 40 can be mounted between the panel supporting part 80 and the light guide plate 50 or between the panel supporting part 80 and the light source cover 65.

A width d1 of the upper receiving part 10 surrounding the LCD panel 20 is implemented to allow for an LCD device having a reduced size. Based on the width d1, a width d2 of the panel supporting part 80 is implemented.

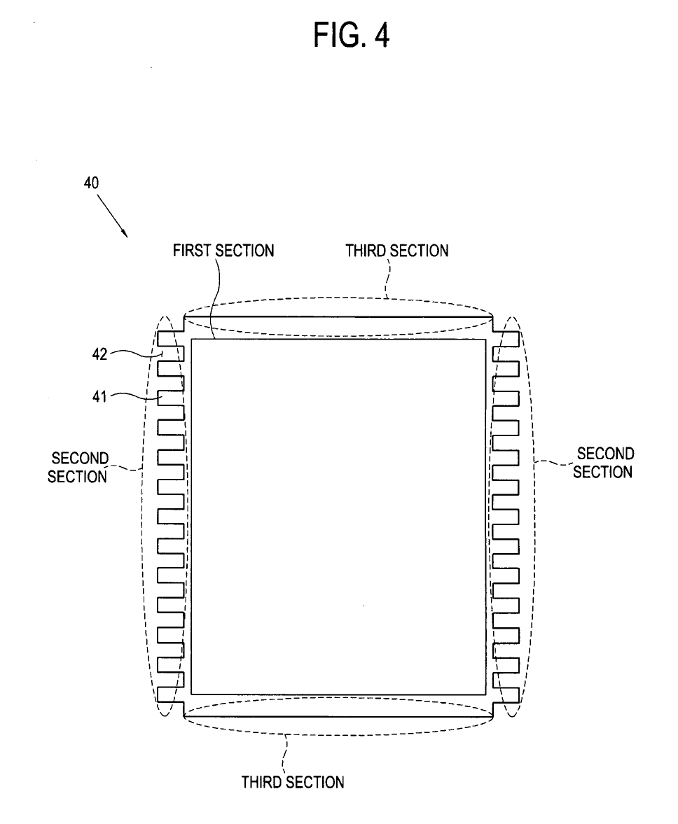

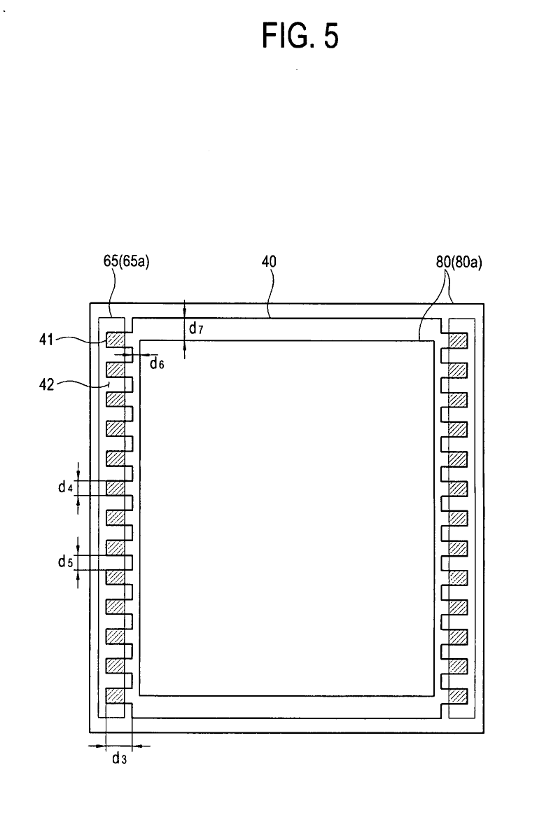

According to the present embodiment, a shape of the optical film 40 improves the efficiency of combination of the optical film 40, which will be described with reference to FIGS. 4 and 5.

As illustrated in FIG. 4, the optical film 40 includes a first section, a second section, and a third section. The first section is an area of the optical film 40 that is not surrounded by the panel supporting part 80 and faces the LCD panel. The second section and the third section are provided below the first part 80a of the panel supporting part 80. If the second section and the third section are increased in size, the optical film 40 can be more efficiently supported.

The second section is provided along a longer side of the optical film 40, e.g., along an extending direction of the light source part 60. A protrusion part 41 and a cut part 42 are alternately formed on the second section. The protrusion part 41 having a rectangular shape is regularly formed in the second section. The third section is provided along a shorter side of the optical film 40, e.g., perpendicular to the extending direction of the light source part 60. As illustrated in FIG. 5, a part of the protrusion part 41, i.e., a hatched area, faces the first side 65a of the light source cover 65. If the LCD device 1 is driven, the light source part 60 generates heat to thereby increase the temperature of the light source cover 65. If the optical film 40 faces the light source cover 65 having an increased temperature, the optical film 40 may be deformed by the increased temperature. If the optical film 40 is deformed, a spot may be formed on a corresponding screen, to thereby lower a quality of the LCD device.

According to the present embodiment, the protrusion part 41 is at least partially superposed on part of the first side area 65a of the light source cover 65 (see FIGS. 3 and 5). Accordingly, part of the optical film 40 faces the first side 65a of the light source part 60, to thereby decrease a deformation of the optical film 40 due to the generated heat. That is, even if the protrusion parts 41 are deformed, the cut parts 42 provided between the protrusion parts 41 absorb the deformation of the protrusion parts 41, to thereby prevent the deformation from being transmitted to the first section.

In addition, the optical film 40 is more efficiently supported by the optical film 40 facing the light source cover 65. That is, an area of the optical film 40 supported by the panel supporting part 80 is increased in size as a result of the second section of the optical film 40 facing the light source cover 65. The increased area may be a hatched area of the optical film 40 facing the light source cover 65, (i.e., the protrusion part 41).

A length d3, and a width d4 of a protrusion part 41, and a distance d5 between a protrusion part 41 and a neighboring protrusion part 41 may vary as necessary. For example, if the optical film 40 is more susceptible to deformation by heat, or if the temperature of the light source cover 65 is highly increased, the width d4 can be narrower, and the distance d5 can be wider.

Part of the second section may fact the panel supporting part 80. Further, the third section also faces the panel supporting part 80. As can be seen from FIGS. 4 and 5, the third section and part of the second section are continuous. A width d6 of the continuous part of the second section facing the panel supporting part 80 is narrower than a width d7 of the third section facing the panel supporting part 80. The width d7 may be wider than the width d6 because the third section does not face the light source cover 65.

As described above, according to the embodiment of the present invention described in connection with FIGS. 1-5, the deformation of the optical film 40 can be decreased, and at the same time, the efficiency of supporting of the optical film 40 can be improved.

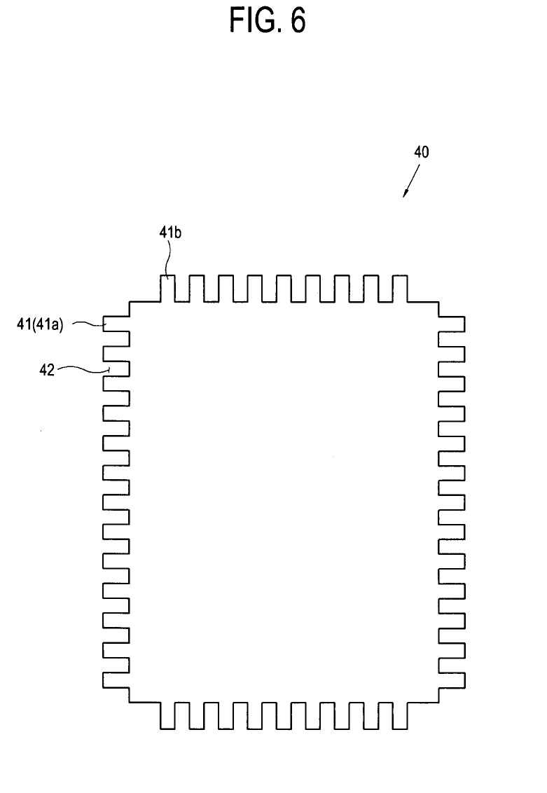

As illustrated in FIG. 6, according to an embodiment of the present invention, protrusion parts 41 are formed on four sides of the optical film 40. The protrusion parts 41 include first sub protrusion parts 41a provided in the second section, and second subprotrusion parts 41b provided in the third section. The optical film can be efficiently supported through the second sub protrusion parts 41b in the third section.

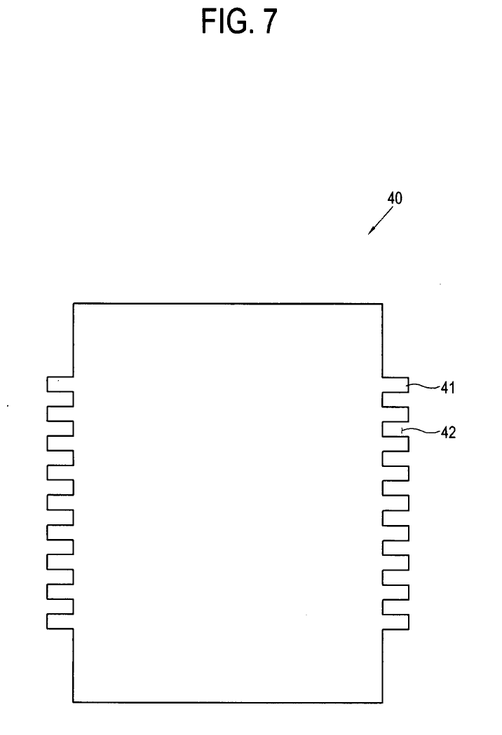

As illustrated in FIG. 7, according to an embodiment of the present invention, the protrusion parts 41 are not formed on the entire of opposite sides of the second section. The opposite sides of the second section where the protrusions 41 are not formed correspond to opposite ends of the lamp 61 of each light source 60. An electrode (not shown) of the lamp 61 is provided at the opposite ends of each lamp, where more heat is generated than in other parts.

The protrusion parts 41 are not formed in those parts of the second section where more heat is generated, to thereby decrease the deformation of the optical film 40.

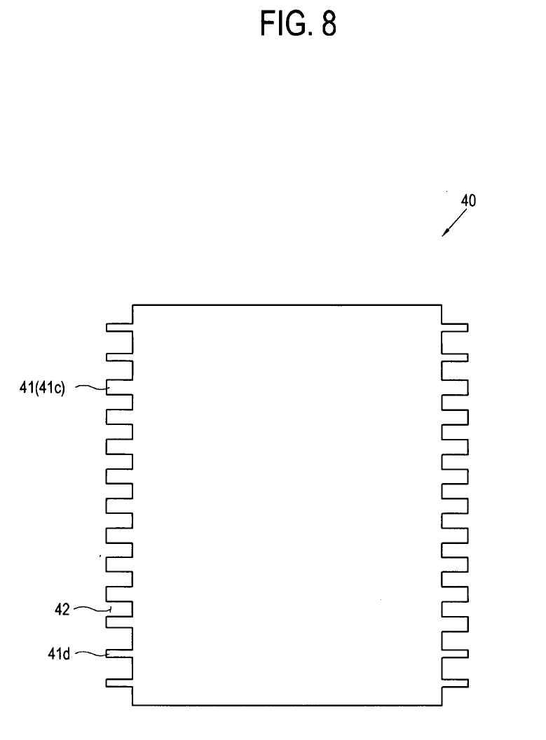

As illustrated in FIG. 8, according to an embodiment of the present invention, the protrusion parts 41 include first sub protrusion parts 41c provided in a center part of the second section, and second sub protrusion parts 41d provided at end parts of the second section next to the center parts.

The width of the second sub protrusion parts 41d is narrower than that of the first sub protrusion parts 41c, and the distance between the second sub protrusion parts 41d is wider than that between the first sub protrusion parts 41c. That is, the end parts of the second section have a lower density of the protrusion parts 41 than the center parts of the second section. The density of the protrusion parts 41 indicates an area occupied by the protrusion parts 41 per unit area of the light source cover 65.

Accordingly, in the embodiment described in connection with FIG. 8, the deformation of the protrusion parts 41 is decreased in the end parts because the end parts of the second section have a lower density of protrusion parts 41.

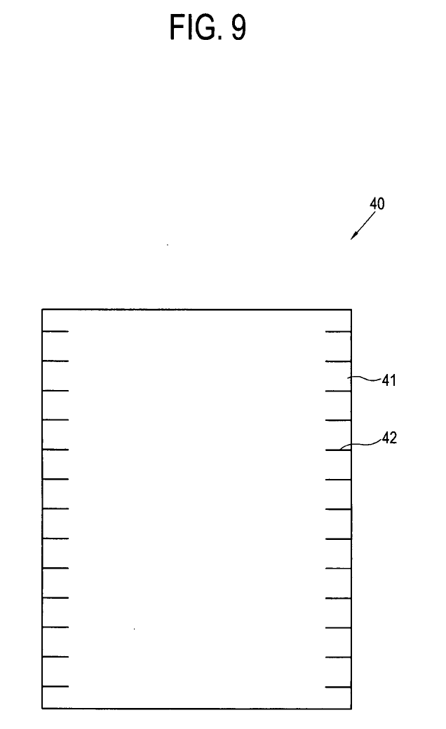

As illustrated in FIG. 9, according to an embodiment of the present invention, the protrusion parts 41 contact each other. The protrusion parts 41 are formed by cutting the optical film 40. The cut part 42 is formed as a cut area of the optical film 40. The protrusion parts 41 facing the light source cover 65 discharge heat through the cut areas (cut parts 42) of the optical film 40, to thereby decrease deformation of the optical film 40. Further, even if a protrusion part 41 is deformed, the deformation of the protrusion part 41 is not transmitted to the first section due to the cut area.

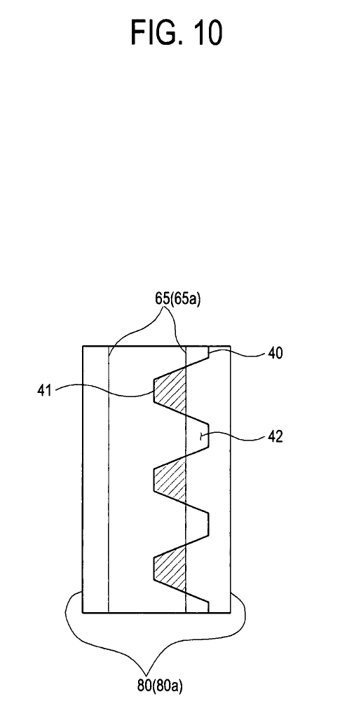

As illustrated in FIG. 10, according to an embodiment of the present invention, the protrusion parts 41 each have a trapezoid shape. The protrusion parts 41 become narrower as a length between the protrusion part 41 and the light guide plate 50 increases. The protrusion part 41 is at least partially superposed on part of the first side area 65a of the light source cover 65.

An amount of light provided from the optical film 40 may be adjusted according to the shape of the protrusion part 41, to result in part of the screen brightness being non-uniform. A shape of the cut part 42 is not suddenly changed but is smoothly changed. That is, the cut part 42 gradually becomes wider as the length between the cut part 42 and the light guide plate 50 increases. As a result, the decrease in uniformity is gradual and increases with greater distance from the first section so as to have no appreciable effect on display quality.

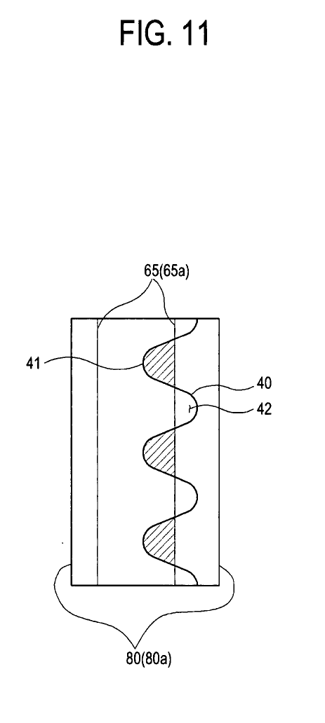

As illustrated in FIG. 11, according to an embodiment of the present invention, the protrusion parts 41 each have a wave shape. The protrusion parts 41 become narrower as a length between the protrusion part 41 and the light guide plate 50 increases. The protrusion parts 41 are partially superposed on part of the first side area 65a of the light source cover 65.

An area of each protrusion part 41 superposed on the first side area 65a has a semicircle shape. Like the embodiment described in connection with FIG. 10, the uniformity of the light can be gradually decreased with increased distance from the first section so as to have no appreciable effect on display quality.

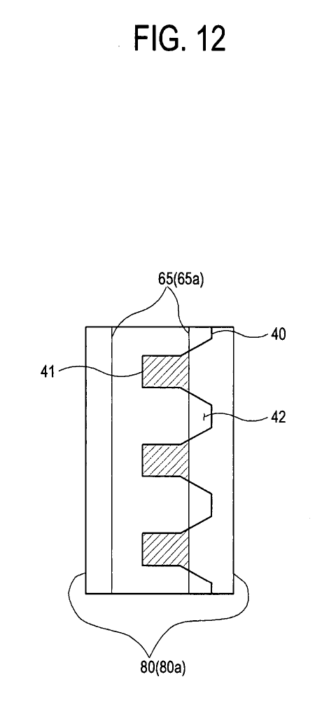

As illustrated in FIG. 12, according to an embodiment of the present invention, the protrusion parts 41 each have a hexagonal shape. The protrusion parts 41 become narrower as a length between the protrusion part 41 and the light guide plate 50 increases. The protrusion parts 41 are partially superposed on part of the first side area 65a of the light source cover 65.

Like the embodiment described in connection with FIG. 10, the uniformity of the light can be gradually decreased with increased distance from the first section so as to have no appreciable effect on display quality.

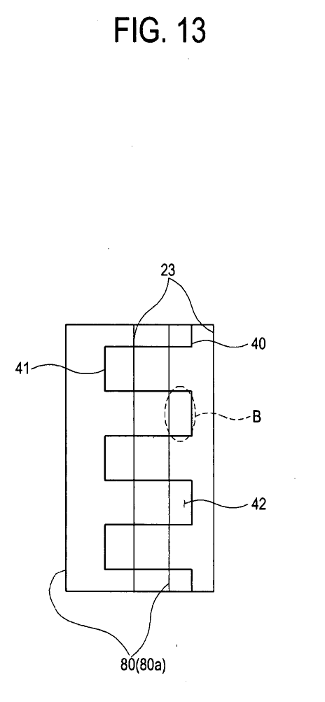

As illustrated in FIG. 13, according to an embodiment of the present invention, the protrusion parts 41 extend to the first section. The optical film 40 facing the LCD panel includes a cut portion B. Here, the cut portion B is provided by partially cutting the optical film 40.

Although the cut portion B may cause the non-uniform light distribution, the cut portion B is provided below the outer black matrix 23, to thereby have no influence on the display quality. In addition, protrusion parts 41 of previous embodiments which do not extend to the first section do not have an appreciable effect on display quality at least because of their location outside of the first section.

According to the present embodiment, deformation of the optical film can be further decreased because the protrusion parts 41 extend to the first section, to thereby prevent the deformation of the protrusion parts 41 facing the light source cover 65 from being transmitted to the first section.

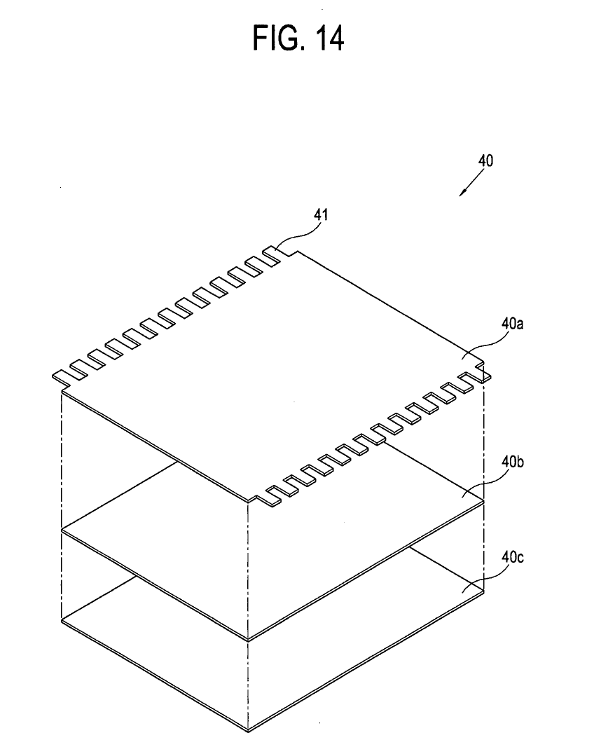

As illustrated in FIG. 14, according to an embodiment of the present invention, the optical part 40 includes three sub optical films 40a, 40b, and 40c.

The sub optical film 40a, which directly faces the LCD panel 20, is provided to be larger than the other sub optical films 40b and 40c. The protrusion parts 41 are formed on opposite side parts of the sub optical film 40a.

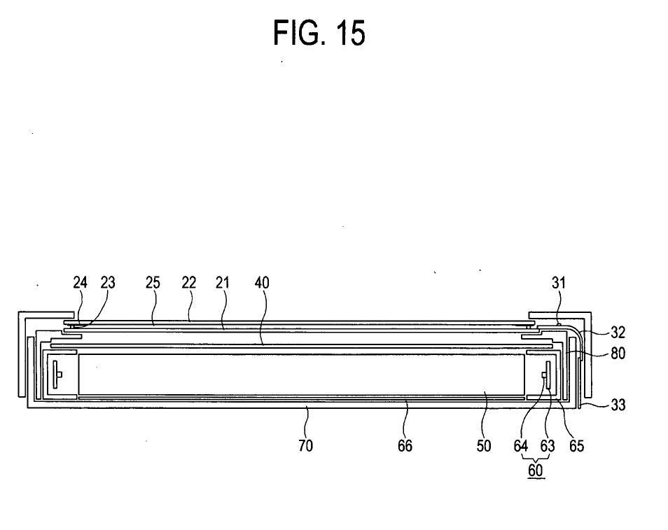

As illustrated in FIG. 15, according to an embodiment of the present invention, the light source part 60 includes a light source circuit board 63, and a luminescent diode 64 mounted on the light source circuit board 63. The luminescent diode 64 may be uniformly mounted on the light source circuit board 63. Accordingly, the deformation of the optical film 40 can be decreased, and at the same time, support for the optical film 40 can be improved.

According to embodiments of the present invention, there is provided an LCD device including an optical film capable of being stably supported.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A liquid crystal display device, comprising:
a liquid crystal display panel;
a light source part disposed along at least one side of the liquid crystal display panel;
a light source cover, the light source cover reflecting light emitted from the light source part to the liquid crystal display panel;
a panel supporting part disposed under an edge part of the liquid crystal display panel to support the liquid crystal display panel; and
an optical film disposed under the liquid crystal display panel, and comprising a first area facing the liquid crystal display panel, and a second area extending below the panel supporting part, the second area comprising a plurality of protrusion parts and a plurality of cut parts alternately formed at an end of the second area, and
at least part of the protrusion parts are provided on the light source cover.

2. The liquid crystal display device according to claim 1, wherein the cut parts extend into the first area.

3. The liquid crystal display device according to claim 1, wherein the protrusion parts are partially superposed on the light source cover.

4. The liquid crystal display device according to claim 3, wherein each of the protrusion parts facing the light source cover comprise at least one of a rectangular, a trapezoid, or a semicircular shape.

5. The liquid crystal display device according to claim 1, wherein the cut parts become wider as a distance between the cut parts and the first area increases.

6. The liquid crystal display device according to claim 1, wherein the protrusion parts extend to the first area,
the liquid crystal display panel comprises an outer black matrix formed along a perimeter of the liquid crystal display panel, and
the protrusion parts are positioned below the outer black matrix.

7. The liquid crystal display device according to claim 3, wherein the light source part comprises a lamp; and
the density of the protrusion parts corresponding to ends of the light source part is lower than the density of the protrusion parts corresponding to a center part of the light source part.

8. The liquid crystal display device according to claim 3, wherein the light source part comprises a light emitting diode, and
the density of the protrusion parts is uniform.

9. The liquid crystal display device according to claim 3, wherein the optical film comprises a plurality of sub-optical films, and
the protrusion parts are formed on the uppermost sub-optical film.

10. The liquid crystal display device according to claim 9, wherein the uppermost sub-optical film is larger than the other sub-optical films.

11. The liquid crystal display device according to claim 3, wherein the optical film has a square shape, and the protrusion parts are formed on four sides of the optical film.

12. A liquid crystal display device, comprising:
a liquid crystal display panel;
a light source part disposed along at least one side of the liquid crystal display panel;
a light source cover, the light source cover reflecting light emitted from the light source part to the liquid crystal display panel;
a panel supporting part, the panel supporting part supporting the liquid crystal display panel; and
an optical film disposed under the liquid crystal display panel, the optical film extending between the panel supporting part and the light source cover, and comprising a plurality of protrusion parts and a plurality of cut parts alternately formed at an end of the optical film,
wherein the protrusion parts are partially superposed on the light source cover.

13. The liquid crystal display device according to claim 12, wherein a cut part not facing the light source cover becomes wider as a distance between the cut part and a center portion of the light guide plate increases.

14. A liquid crystal display device, comprising:
a liquid crystal display panel;
a light source part disposed along at least one side of the liquid crystal display panel;
a light source cover, the light source cover reflecting light emitted from the light source part to the liquid crystal display panel;
a panel supporting part disposed under an edge part of the liquid crystal display panel to support the liquid crystal display panel; and
an optical film disposed under the liquid crystal display panel, and comprising a first area facing the liquid crystal display panel, and a second area extending below the panel supporting part, the second area comprising a plurality of protrusion parts and a plurality of cut parts alternately formed at an end of the second area.

15. The liquid crystal display device according to claim 14, wherein at least part of the protrusion parts are provided on the light source cover.

16. The liquid crystal display device according to claim 15, wherein the cut parts extend into the first area.

17. The liquid crystal display device according to claim 15, wherein the protrusion parts extend to the first area,
the liquid crystal display panel comprises an outer black matrix formed along a perimeter of the liquid crystal display panel, and
the protrusion parts are positioned below the outer black matrix.

18. The liquid crystal display device according to claim 15, wherein the light source part comprises a lamp; and
the density of the protrusion parts corresponding to ends of the light source part is lower than the density of the protrusion parts corresponding to a center part of the light source part.

19. The liquid crystal display device according to claim 15, wherein the optical film comprises a plurality of sub-optical films, and
the protrusion parts are formed on the uppermost sub-optical film.

20. The liquid crystal display device according to claim 15, wherein the optical film has a square shape, and the protrusion parts are formed on four sides of the optical film.
